(19) United States
(12) Patent Application Publication
(10) Pub. No.: US 2012/0072377 A1
(43) Pub. Date: Mar. 22, 2012

(54) Credit and debit card return service CRS

(76) Inventor: Charlie Sherrod, Marietta, GA (US)

(21) Appl. No.: 12/807,988

(22) Filed: Sep. 17, 2010

(51) Int. Cl. G06Q 90/00

(52) U.S. Cl. 705/500

(57) ABSTRACT

A consumer card return service would be created where a company entitled, Card Return Service, CRS, with the tangible service of retrieving left behind credit cards at restaurants, bars and night clubs and quickly getting these left behind cards back into the hands of the consumer.

This service will potentially save many millions of dollars for the card issuers, relieve merchants of the burden of storing and protecting the cards, and create happy consumers by getting their cards back into their hands more quickly.

We contend this new service will benefit consumers and that the newly created Consumer Financial Protection Agency, who provides oversight on card debit and credit fees, will approve any consumer fees that may be required to sustain this new idea. Approval will be granted because this service will be viewed as consumer protection, literally and figuratively.

### CROSS-REFERENCE TO RELATED APPLICATIONS

None.

### STATEMENT REGARDING FEDERALLY SPONSORED RESEARCH OR DEVELOPMENT

None.

### THE NAMES OF THE PARTIES TO A JOINT RESEARCH AGREEMENT

None.

### REFERENCE TO A TABLE

FIG. 1 and FIG. 2 US credit card information for 2009 numbers from www. creditcard.com website statistics.

### BACKGROUND OF THE INVENTION

Presently, in restaurants, bars and retail establishments around the United States the merchants find themselves in the possession of credit and debit cards that consumers have unintentionally left or lost at their establishments. This creates problematic issues for the credit card owner, the merchant and the credit card issuer.

No one is served well by not having a process or service to retrieve left behind cards at establishments, which are mostly restaurants, bars and nightclubs. Left behind cards result in dissatisfied consumers, merchants and card issuing companies. With a credit card return service in place a consumer can have their credit card returned to them in an expeditious fashion thus relieving stress and anxiety and allowing the consumer to utilize the card again within a 24 hour period. The credit card issuer will not need to issue a new card and close out the existing account. This will save the credit card issuer millions of dollars and time in customer service actions and processing and creating new cards for the consumer. This will allow the merchant fees to continue with use of the card within 24 hours.

Very importantly, we believe this is a significant consumer benefit as the card holder will not be concerned with contacting the merchant where they surmise “they might have left a card” or certainly contacting the myriad of merchants where they had registered their card numbers for ongoing and recurring debits.

1. Field of Invention

The present invention relates generally to a method for initiating the return of credit cards left behind in retail establishments. A Credit and Debit Card Return Services (CRS) is looking to create and penetrate a market that presently does not exist and is logically untapped.

2. Description of Related Art

None.

### BRIEF SUMMARY OF INVENTION

A consumer card return service would be created where a company entitled, Card Return Service, CRS, with the tangible service of retrieving left behind credit cards at restaurants, bars and night clubs and quickly getting these left behind cards back into the hands of the consumer either by overnight delivery or in person, if a hardship exists.

Currently, left behind cards result in unhappy merchants, dissatisfied consumers and is very costly to the card companies.

This service will save many millions of dollars for the card issuers, relieve merchants of the burden of storing and protecting the cards, and create happy consumers by getting their cards back into their hands more quickly

### BRIEF DESCRIPTION OF SEVERAL VIEWS OF DRAWINGS

None.

### DETAILED DESCRIPTION OF INVENTION

### CRS Would Operate as Follows:

1. Form a legal and financial bonded relationship with credit and debit card issuers—AMEX, VISA, DINERS Club, MASTERCARD, JTB, etc;—within this contractual relationship the card issuers would create a new term and condition within the consumer contract. This term reads something like the following—“If our card return representative reports your card left behind at a merchant establishment—before you collect the card by the merchant closing time or report your card lost or stolen—you will be debited a $25 return and return charge. For this fee you will be contacted and your card will be locally returned via overnight delivery.”
2. Establish territories in major metropolitan cities where 80% of all card expenditures are enacted and where the high volume restaurants, clubs, and nightclubs are located. Credit Card Retrieval and Return, CSRs (customer service reps), would establish formal relationships with these merchants. Initially, we believe a CSR can handle 100 merchant accounts per territory. These reps would work within a CRS central location within the metro area covered.
3. Contact with the merchant by the CRS CSR within their territory would happen daily at night or after the establishment closes to ascertain if any cards have been left behind. If cards have been left the merchant verbally gives the card names and numbers to the CSR. We estimate this process to take 10 minutes or less. Note: The merchant is motivated to do this for many reasons—1. eliminates their burden of holding and protecting the card 2. The merchant does not have time to contact the consumers or interface with them when they want to retrieve cards.
4. CRS immediately contacts the card company to report the card as “retrieved”. The card company immediately assesses the $25.00 card return and return charge against the consumer account. Note: CRS, if the consumer writes an appeal via the normal card dispute system—CRS will work with the card company to investigate the complaint and if needed, waive the $25 charge. This ensures consumer protection if they feel they could have retrieved the card on their own or if they would have preferred to receive a free card from the card company and wait for 3-5 days to retrieve it. Note: we believe most consumers will value the service since they do not have to change all the electronic bill paying relationships that may be established with the existing card number and most will not want to wait 3-5 days for a new card. Further, if there is an immediate hardship or need CRS will return the card in person within the territory and collect a signature on the spot.
5. Contact with the consumer is immediate. The call would go like this, “Good evening Mr. Jones, “This is Karen Scott with The Card Return and Return Service. We have your card; you left it at XYZ merchant. XYZ merchant values you as a customer and along with XYZ card company we want to get this card safely back into your hands as quickly as possible. You may receive your card back in one of two ways:
   a. we can meet you and hand you the card. You will have to have proof of identification and sign for the card,
   b. or, we can overnight the card with a signature required to your address on file.
6. CRS then provides the card issuer the detailed information where the consumer did receive the card either by overnight carrier or an in person delivery. The card issuer, monthly process payments to CRS for each of the validated or proven, via consumers signature, card returns. Note: The card company would incur this payment system because they are now avoiding millions of dollars by not having to replace cards themselves. This step will be highly automated.
7. Return of the cards occurs that night at closing time or the next morning. Whichever is convenient for the merchant and logistically feasible for CRS.
8. Return of the cards happens the next day via in person delivery where a signature will be required or most likely via an overnight delivery via established carriers. Proof of identity and receipt will be required in either case and proof of receipt will be provided to the card issuer.

### Note #1:

All employees handling retrieved credit cards will be bonded and insured and adhere to all financial company rules and regulations required to handle money and other financial instruments.

All employees will be trained in the Malcolm Baldrige Customer Satisfaction Training.

All assets, while in the possession of CRS will be handled in a secure fashion. CRS will equip vehicles with lockable units for their vehicles.

### Note #2.

We contend this process and details of the service also reflexively identifies THE BEST MODE of the Invention.

### Problems Solved with Invention

1. The consumer may leave behind their credit or debit card when paying their bill or at bars and clubs have an open tab and forget to close out their tab—IMPLICATION: The merchant now accepts the burden of protecting the card until the consumer retrieves same. Merchants do not like assuming this responsibility.
2. The consumer, in many cases does not know when and where the card became missing. IMPLICATION: Once the consumer realizes the card is missing—the next day—they spend much time searching for the card and anxiety sets in as to where the card is. They think that it might be lost and that it may be being misused. They most often will call the card company, report the card lost or stolen. Then they must wait days to get a new card.
3. The merchant has the burden of responsibility while the credit card is in their possession. IMPLICATION: The merchant must lock it in a safe and be accountable for the credit card until it is returned to the owner or destroyed. Merchants do not like having this responsibility. If they cut the card up and the consumer returns, the consumer is unhappy. Since the establishment is not bonded, they are retaining a consumer asset without receiving any benefit. There is no process whereby the merchant calls the card company to formally report they are holding a person card. Further, the merchant does not have time to devote to this activity. Further, the potential exists for cards to be moved/disappear causing potential liability to the merchant
4. The card company implications are many in this process. IMPLICATIONS: The card company has an unhappy consumer and an unhappy merchant. The credit card company then has to send the consumer a temporary credit card or replace the lost/stolen credit card with a new account number. This entails shipping fees and customer service support time.

In summary, no one is served well by not having a process or service to retrieve left behind cards at establishments, which are mostly restaurants, bars and nightclubs. Left behind cards result in dissatisfied consumers, merchants and card issuing companies.

### Brief Description of Financial Implications

The following is a high level snapshot, FIG. 1 is of the financial implications of not retrieving and returning left behind cards and having to replace cards. FIG. 2 represents the value lost when merchant fees are not collected by the credit card issuer. Since the financial implications are MACRO in nature we believe for the purpose of this USPTO patent submission a very high level snapshot will suffice.

Naturally, as we approach the card companies with the service idea we will engage in due diligence and produce an extremely detailed business plan and study the market in a granular approach.

Currently Credit and Debit Card Companies expend millions replacing lost or left behind cards. The following is an estimate of the costs US Card companies expend each year replacing cards needlessly.

FIG. 1

| | % | | | |
|---|---|---|---|---|
| | restaurant, | Total Left | +Real costs | |
| | bar, night | Behind | to replace | |
| | club left | cards to be | a card | |
| USA Credit Cards | behind cards | replaced | per unit | Total |
| 181,000,000 | 10% | 18,100,000 | $25 | $452,500,000 |
| US Census Bureau | estimate | | Estimate | |
| Low Estimate | | | | |

+includes CSR (customer service rep time), legacy accounting to keep up with old numbers, and overnight or US Mail shipping cards to consumers.

FIG. 2

| Amounts | Description |
|---|---|
| $310,000,000,000.00 | Total Credit Card Expenditures, 2009 |
| $7,750,000,000.00 | 2.5% conservative average estimate of |
| | merchant fees collected in one year |
| | Note: It takes an average of 3 days to get a |
| | card replaced by the issuer |
| $1,061,643.84 | Estimate of 5% of cards or expenditures |
| | removed daily if card is not used |
| $128,458,904.11 | 121 is the set of 3 day periods that the cards |
| | are not being utilized while consumer awaits |
| | their card to be replaced. This is the grand |
| | total of 121 times the daily fees not collected |
| | while the consumer awaits a card replacement |

In summary, we believe our very rough estimates using some Census bureau data highlighting the enormous financial implications for the card companies when consumers leave their cards behind at restaurants, bars and nightclubs.

If five hundred and eighty million dollars a year is the current expense exposure for card companies, one can see that this is a MACRO business problem to be solved and the financial implications are MACRO.

We contend beyond any reasonable doubt that this offers real world value.

### Tangible Results Derived (Real World Value)

a. Credit Card Company: The credit card company benefits by eliminating the millions of dollars in card replacement costs. The credit card company has cost avoidance of closing an account and creating a new account and issuing a new card to the consumer. The credit card company reduces the time spent by customer service dealing with credit card return issues directly with the consumer. Eliminates “no merchant fees” gap while consumers await their newly issued cards by the credit card company. We have established rough order of magnitude numbers of five hundred and eighty million dollars.
b. Merchant: The merchant benefits by not having the liability and responsibility for holding a credit card for 30+ days. The merchant frees up time for its management and employees not having to deal with such credit card return issues with the consumer. The Merchant is credited and valued by the consumer for being party to getting their card back to them quickly and efficiently. The merchant can focus on his core business, not managing a consumer asset. The ability to return the card promptly to the consumer brings an implied customer service value.
c. Consumer: The consumer does not have to spend time with their credit card customer service reporting and ordering a new card. Knowing that someone else is not using their credit card but in the hands of a bonded return service, CRS, and that their card will be returned to them promptly reduces the consumer's anxiety.

### Sequence Listing

None.

### IV. Best Known Other Practices

To date we are not aware of any other best practice that exists which contacts the restaurants, clubs and other establishments to relieve the merchant of the burden of the left behind cards, get the card back into the consumer's hands as quickly as possible, and eliminate the expense of replacing the cards for the card company. Further, merchant sales from the card will continue as the consumer has the card in his or her possession and starts spending more quickly.

### VI. Summary

CRS, the company offers an entirely new card return and return service where all parties legitimately benefit. This service does not now or has not in the past existed or has been implemented by the card companies.

The invention description has been mapped out step by step and this methodical process description also presents the best mode of the invention.

Tangible or real concrete results have been quantified and the service will be a win for the consumer, the merchant and the card issuing company.

We look forward to a successful award for a USPO business method process patent of the idea. Once this patent is awarded we intend to create a comprehensive business case and approach all of the card companies.

### Author Background: Charlie J. Sherrod

1974-1977—US Military, Marine Corps Air Station, Iwakuni, Japan
American Spirit Honor Medal
Thomas Jefferson DOD Award

1977-1981—East Carolina University, BS Degree
served on the University Board of Trustees
served on the University Board of Trustees Exec Council
served on the University Athletic Council
served on the University Student Union Council
student body Vice-President, 1980
student body President, 1981

1981-1985, Xerox Corporation, National Account Manager

1985-1999—IBM Corporation, Marketing Communications Manager

1999-present, founder and CEO, efilms, Incorporated

The invention claimed is:

1. I claim a method for return and return of left behind credit cards at restaurants, bars and night clubs and expeditiously getting these cards back into the hands of the owner without the owner of the card having to go to their credit card issuer to cancel the card and issue a new one.

2. I claim the method wherein claim 1 includes steps of contacting the retail establishments for notification of any credit cards in their possession which were left by consumers.

3. I claim the method wherein claim 2 further includes CRS obtaining consumer information for said cards left behind from the credit card issuer.

4. I claim the method wherein claim 3 includes direct contact with the credit card owner and notifies the consumer that their card can be properly returned without closing their account and requesting a new credit card.

5. I claim the method of claim 4 wherein contact is made with the consumer, CRS arranges delivery of credit card to the owner and requires signature at time of delivery.

6. I claim the method of claim 5 includes notification of said delivery to the credit issuer that the card is in fact in the hands of the rightful owner and a credit card return fee is to be processed by the card issuer for the safe delivery of the card to the owner in an expeditious fashion.

7. I claim the method wherein claim 6 includes payment to CRS for return of the credit card to the owner by the credit card issuer.
